(19) United States
(12) Patent Application Publication
(10) Pub. No.: US 2024/0249166 A1
(43) Pub. Date: Jul. 25, 2024

(54) SYSTEM FOR AND METHOD OF DETERMINING CORROSION RISKS

(71) Applicant: ANSYS UK LIMITED, Canonsburg, PA (US)

(72) Inventors: Nicholas Ekow Austin, Cambridge (GB); David Cebon, Cambridge (GB); Thomas James Alexander Prankerd Smith, Cambridge (GB); Thomas Hugh Riddell Smith, Cambridge (GB)

(21) Appl. No.: 18/374,898

(22) Filed: Sep. 29, 2023

Related U.S. Application Data
(63) Continuation of application No. 14/865,795, filed on Sep. 25, 2015, now abandoned.

(30) Foreign Application Priority Data
Sep. 26, 2014 (GB) 1417081.5

(51) Int. Cl. G06N 5/04; G06F 30/00

(52) U.S. Cl. CPC G06N 5/04; G06F 30/00

(57) ABSTRACT

A system for identifying a corrosion risk during the design of a mechanical assembly, the system comprising: a design data unit for storing design data representing the mechanical assembly; a corrosion data unit for storing corrosion data; and a processor configured to: obtain design data from the design data unit; obtain, from the corrosion data unit, corrosion data relevant to the obtained design data; make a comparison of the obtained design data with the obtained corrosion data to identify a corrosion risk associated with the design; and provide, based on said comparison, an indication of the corrosion risk.

### CROSS-REFERENCE TO RELATED APPLICATIONS

The present application claims priority from U.S. patent application Ser. No. 14/865,795, titled “SYSTEM AND METHOD OF DETERMINING CORROSION RISKS,” filed Sep. 25, 2015, which itself claims priority from Great Britain Patent Application No. 1417081.5, filed Sep. 26, 2014, the disclosure of each of which are hereby incorporated herein by reference.

### FIELD OF THE INVENTION

The present invention generally relates to a system for and a related method of determining corrosion risks during the design of mechanical assemblies.

### BACKGROUND OF THE INVENTION

Systems for aiding the design of mechanical assemblies are well known and the use of modelling tools such as Computer Aided Design (CAD) software, for example, is widespread. It is also well known that predicting risks associated with the design of mechanical assemblies is paramount.

In particular, identifying a risk of corrosion during the design of mechanical assemblies is an important safety requirement. In order to predict corrosion, existing systems use finite element analysis (FEA) to produce detailed models of electrochemical processes that occur where solid materials interact with fluid environments. Calculations involved in such models, however, are expensive and are impractical for large mechanical assemblies. At present, there are no systems available that give an overview of likely risk areas when designing mechanical assemblies. Identifying risks during the design phase is desirable in order to allow the designer to make the necessary investigations and/or changes to the design, as required.

### SUMMARY OF THE INVENTION

The present invention seeks to overcome the problems associated with existing systems.

According to the present invention there is provided a system for identifying a corrosion risk during the design of a mechanical assembly, the system comprising: a design data unit for storing design data representing the mechanical assembly; a corrosion data unit for storing corrosion data; and a processor configured to: obtain design data from the design data unit; obtain, from the corrosion data unit, corrosion data relevant to the obtained design data; make a comparison of the obtained design data with the obtained corrosion data to identify a corrosion risk associated with the design; and provide, based on said comparison, an indication of the corrosion risk.

The system therefore uses analysis of design data and identification of a corrosion risk based on this design data. In particular, the system automatically obtains design data during the design operation, which may be carried out, for example, using tools known in the art, for example, CAD systems. With the present system, therefore, it is possible to accurately predict corrosion risk during the design of a mechanical assembly and modify the design at the design stage. It will be appreciated that the words ‘design’ and ‘model’ may be used interchangeably to represent the designed mechanical assembly.

The system according to the present invention represents a corrosion and advice tool that may operate in conjunction with established design tools for mechanical assemblies, including, amongst others, CAD software packages such as Pro/Engineer. Advantageously, the system may be used in the form of a ‘plug-in’ for integration into various software packages.

The obtained design data may comprise at least one part of the mechanical assembly, at least one constituent material associated with the at least one part, and at least one environment for the mechanical assembly. The design data may further comprise a connection between the part and the environment which represents the ‘adjacency’ of the part to the environment, which may lead to the formation of a galvanic circuit. The obtained corrosion data may comprise at least one of a reference material name which may represent part materials or environment materials, environmental durability level associated with the reference material operating in that environment and a galvanic potential associated with a reference material.

Specifically, making a comparison may comprise determining the existence of a galvanic circuit through the at least one environment; and determining a corrosion risk (i.e. galvanic risk) associated with the at least one pair of parts based on the potential difference between their respective constituent materials. The term ‘galvanic circuit’ (also referred to as a ‘galvanic corrosion cell’ or ‘galvanic cell’) is known in the art and will be described in more detail below. A galvanic circuit requires at least one electrical connection (direct or indirect) between the pair of parts, and a potential difference between them.

The word ‘environment’ may represent an environment region adjacent to different parts of the design. The system may advantageously treat an ‘environment’ as a part, when assessing an adjacency matrix, as described in more detail below.

A further advantage is that the corrosion risk may be assessed for multiple distinct environments (for example made of different electrolytes), as well as different regions of the same environment. Both of these cases are important for establishing galvanic cell circuits leading to corrosion.

Determining the existence of a galvanic circuit may comprise: determining whether the parts in the pair are made of distinct constituent materials; determining whether at least one of the part in the pair is an insulator; and determining whether the at least one environment is in contact with both parts in said pair. As such, the adjacency of parts in a design may also be relevant for corrosion behaviour. If an electrical current can pass between two parts other directly or indirectly, then a galvanic corrosion cell can be established. This means that more complex galvanic circuits through many parts need to be detected. Advantageously, the system detects electrical connections where a conductive part is in contact (directly or indirectly) with a conductive environment, and these electrical connections may be factored into indirect connection calculations.

Preferably, the system is configured to generate a corrosion risk report, also referred to as a risk assessment report. This may include links to advice for known cases, and may suggest, for example, alternative designs, materials, coating, or any other appropriate methods known in the art for avoiding corrosion in the specific design at risk. The risk assessment report may include galvanic risks, general risks, and risk ratings.

A galvanic risk refer to risks associated with design parts with a common environment which form a galvanic cell. A galvanic cell is an electrochemical cell wherein two conductive parts in contact with an electrolyte have a conductive path between them, as will be described in more detail below. The potential difference of the galvanic cell can drive electrochemical corrosion of one or more of the parts. Therefore if two parts with a common environment are made of different materials, there may be a corrosion risk which would be reflected in the report.

The processor may be configured to assess the level of the indicated corrosion risk, for example by making a risk analysis. The ‘level’ of a risk would indicate to the designer the importance of that risk. For example, a risk rating may be determined (and included in the risk assessment report), or the risk may simply be dismissed from the report, if such a risk is not consider relevant to the design.

It will be appreciated that environments may be corrosive to materials in many other ways, without the need for a second electrode and galvanic cell. This may be dependent, for example, on durability properties for material-environment pairs. As such, identifying a corrosion risk preferably comprises identifying a general risk associated with the design.

Obtaining design data from the design data unit may comprise generating a design data output file, such as an XML file, for example. The information in the output file may then be mapped, for example, via static look-up, to the obtained corrosion data.

The system may further comprise a report generator for generating a risk assessment report based on the indication provided by the processor. The risk assessment report may include at least one of a galvanic risk, a general risk, and a risk rating which rates the importance of the identified risks.

The obtained corrosion data may comprises at least one corrosion case and advice data, which may be included in the risk assessment report to aid the designer during the design process.

According to the present invention there is also provided a method of identifying a corrosion risk during the design of a mechanical assembly, the method comprising the steps of: obtaining design data representing the mechanical assembly; obtaining corrosion data relevant to the obtained design data; making a comparison of the obtained design data with the obtained corrosion data to identify a corrosion risk associated with the design; and providing, based on said comparison, an indication of the corrosion risk.

### BRIEF DESCRIPTION OF THE DRAWINGS

Specific examples of the invention will now be described in greater detail with reference to the following figures in which:

FIG. 1 schematically represents a system in accordance with the present invention;

FIGS. 2A and 2B represent the most basic galvanic cells;

FIGS. 3A and 3B represent uncompleted galvanic cells;

FIG. 4 represents a galvanic cell with a non-conductive electrode;

FIG. 5 represents a galvanic cell with a non-conductive environment;

FIG. 6A represents galvanic cell paths with two environments;

FIG. 6B represents a double galvanic cell model;

FIG. 7 shows an example model tree;

FIG. 8 is a table representing an example master list of environment regions;

FIG. 9 is a table representing an example environment connection list for a part that is in contact with two environments in the master list shown in FIG. 3;

FIG. 10 is an example of an XML output file representing design data obtained by the system;

FIGS. 11A and 11B respectively show a part table and an environment table used for storing design data;

FIG. 12 schematically represents a method in accordance with the present invention;

FIG. 13 is a schematic representation of a model used for an example risk analysis;

FIGS. 14 and 15 are tables showing examples of risk ratings;

FIG. 16 shows a risk assessment report;

FIG. 17 shows another risk assessment report;

FIG. 18 is an example of a worksheet including corrosion case information;

FIGS. 19A, 19B, and 20 to 25 show further examples of models which have been created to test the system according to the present invention for a variety of corrosion criteria;

FIGS. 26A and 26B respectively show galvanic and general tables from an assessment risk report;

FIG. 27 shows a further risk report;

FIG. 28 is a table representing corrosion cases associated with feature references defined by CAD software; and

FIG. 29 shows octree diagrams.

### DETAILED DESCRIPTION

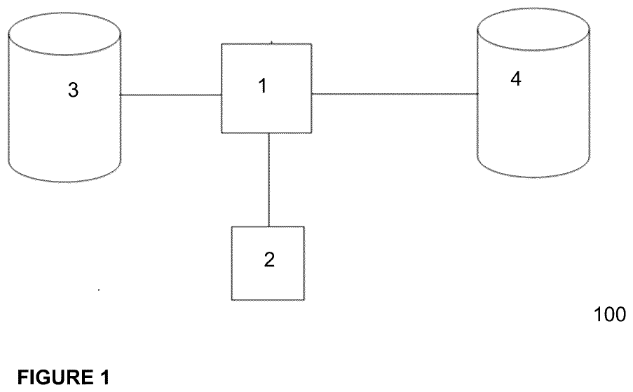

FIG. 1 shows components of a system 100 for identifying a corrosion risk during the design of a mechanical assembly. The system 100 comprises a processor 1 connected to a user interface 2. This connection may be wired or wireless and the user interface 2 may be a personal computer, tablet or smart phone, for example. The processor 1 is coupled to a design data unit 3 which stores information on design data for the mechanical assembly. The processor 1 is configured to obtain design data from the design data unit 3, for use in the corrosion risk analysis. The design data includes parts of the mechanical assembly, materials associated with the parts, and environments (which may be fluid environments, representing electrolytes) that may be in contact with the parts, as well as other information relevant to the design.

The processor 1 is also coupled to a corrosion data unit 4 which holds information relevant to assessing the risk of corrosion based on the design data. The corrosion data unit 4 may include corrosion case information as well as additional data which may be used to compare the obtained design data against, so as to assess the likelihood of corrosion risk. The comparison may be done, for example, by static data look-up for mapping design data such as material names which are assigned to reference the material, information on environmental durability for each material and information on galvanic potential of materials in a standard environment. Each part in the model has an assigned material which would determine how the part will respond to different corrosive situations.

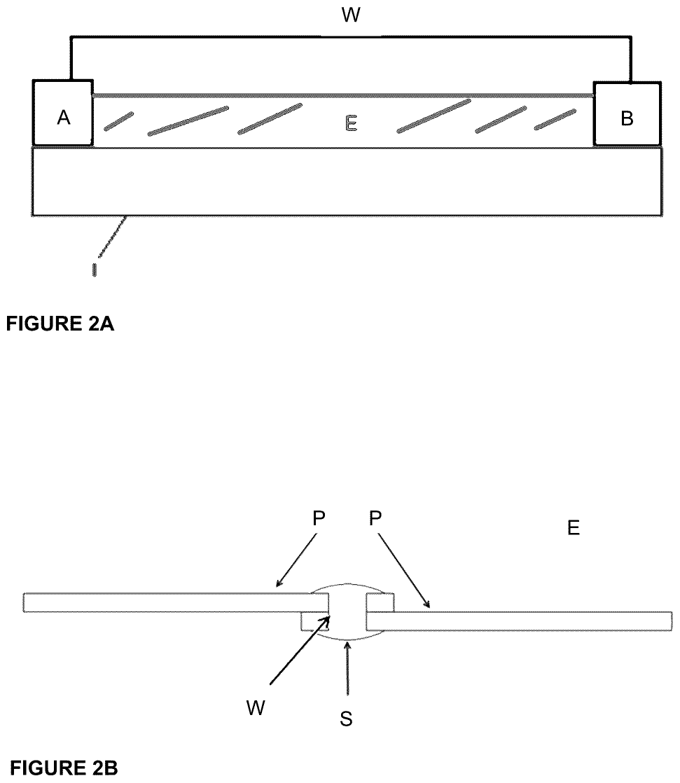

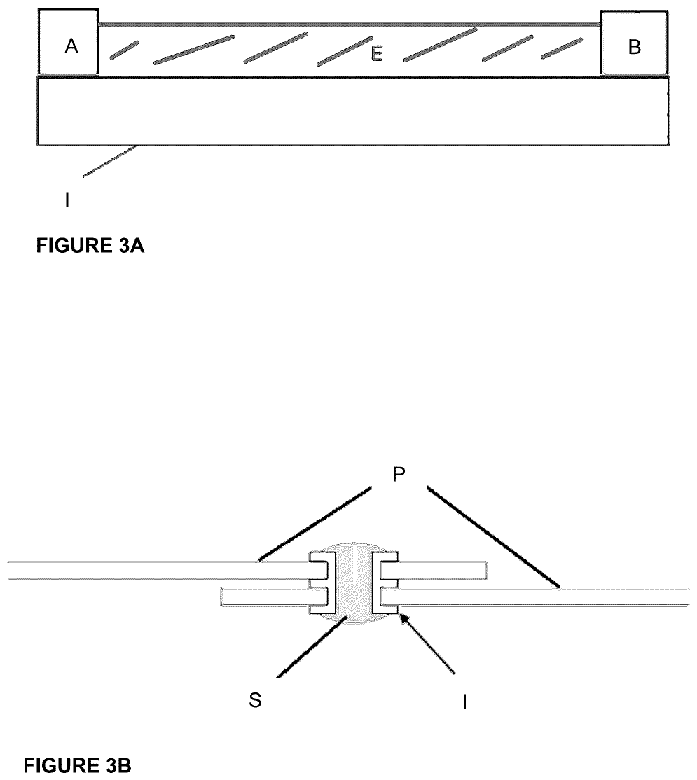

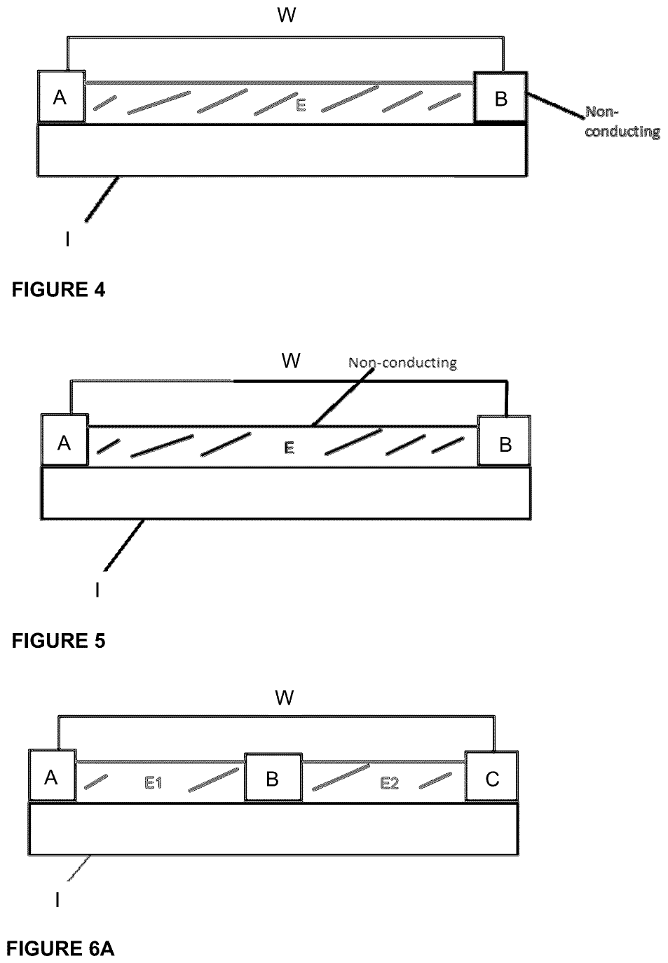

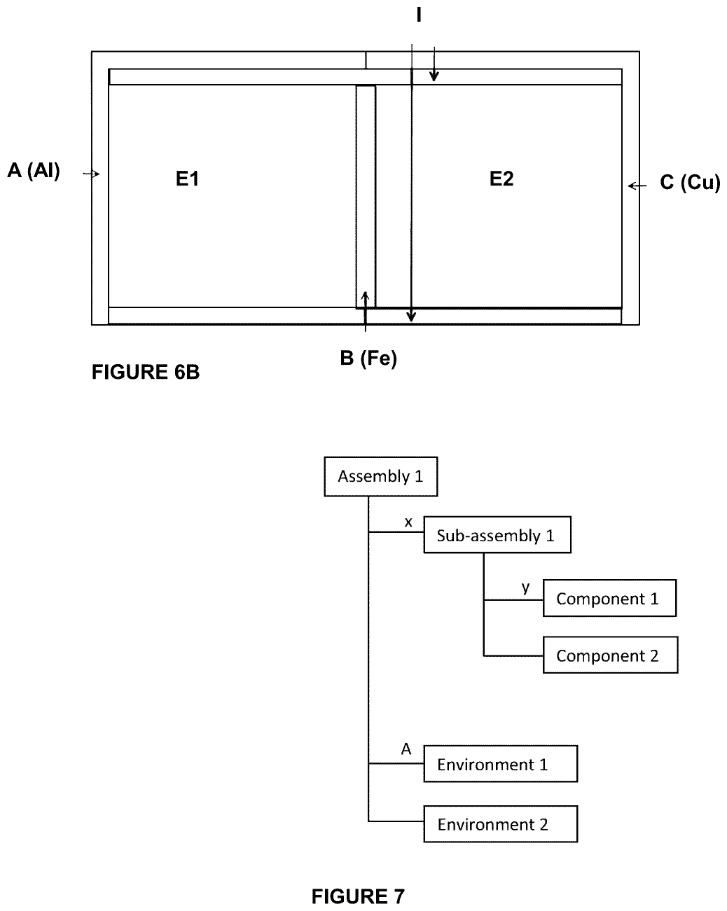

For galvanic corrosion to occur, there are several basic scenarios from which galvanic cells can be built, examples of which are being described herewith. These scenarios include: a basic electrochemical cell, also referred to as a galvanic cell (schematically shown in FIG. 2A), an uncompleted cell (schematically shown in FIG. 3A), a cell with non-conductive electrodes (schematically shown in FIG. 4), a cell with a non-conductive environment (schematically shown in FIG. 5), and cell paths through multiple environments (schematically shown in FIG. 6A).

Referring to FIG. 2A, two parts A and B, made of conductive material (such as steel) are in contact with an electrolyte (such as salt water), which represents an environment E. In this example, the parts are positioned on an insulator I made of an appropriate insulating material (rubber, for example). The two parts, A and B, have a conductive path, also referred to as a return path, w, between them. The conductive path may be either a direct path, or may consist of other conductive paths and environments. As such, the two parts, A and B, act as electrodes, with a potential difference across the cell. In this scenario, the risk assessment is considered to be dependent purely on the galvanic potential difference and not on the nature of the electrolyte or the specific geometry of the cell.

FIG. 2B shows a model of riveted plates which corresponds to the basic electrochemical cell scenario shown in FIG. 2A. In this model, 2 copper plates P, corresponding to part A are in direct contact with an iron or carbon steel bolt S, corresponding to part B, the formed conductive path w being the direct contact between the copper plates and the steel bolt, in a water environment (E).

FIG. 3A schematically shows an “uncompleted cell” scenario. An uncompleted cell is an electrochemical cell which is the same as the basic electrochemical cell shown in FIG. 2A, except there is no separate return path (W) completing the galvanic circuit (in other words, all potential return paths w would go through non-conductive parts of the model). Corrosion may still be possible in uncompleted cells by diffusion of ions between the parts A and B, or some other mechanism. FIG. 3B shows an uncompleted cell formed by two riveted plates P made of a conductive material, such as metal. The plates P are insulated from rivet S with a rubber part I, thereby preventing conductive return path W.

FIG. 4 shows a galvanic cell with no conductive path (as with the uncompleted cells), however, in this case, electrode B is made out of an insulating material. For this scenario, the system does not predict galvanic corrosion.

Some environments may be non-conductive, for example electrolytes such as diesel oil. Non-conductive environments do not provide a conductive path for galvanic cells, as shown in FIG. 5. In order for these scenarios to be accounted for, the environment conductivity may be assessed using static lookup tables, as will be explained in more detail below.

Referring to FIG. 6A, conductive paths through two environments E1 and E2 may exist between three conductive parts, A, B, and C. The current in a basic galvanic cell is limited by the cell potential and the resistance of the conductive path. In this case, however, conduction through environment E2 may be required to complete the A-B cell, while conduction through the environment E1 may be required to complete the B-C cell. If E1 is a low conductivity environment in the case of the B-C cell, this would mean a significantly lower corrosion rate than for the basic galvanic cell equivalent. (Similarly for E2 and the A-B cell.) A worst case approach may be taken, for example by treating the second environment in each circuit as being a good conductor, and then evaluating the A-B, and B-C cells as if they were independent basic cells.

A double cell model as shown in FIG. 6B illustrates the scenario of FIG. 6A. A conductive circuit is formed through conductive parts A, B, C made respectively of aluminum (Al), Iron (Fe) and Copper (Cu) via two separate bodies of salt water (E1 and E2). Insulation parts (I) such as rubber are also provided between the conductive parts.

The manner in which design data is extracted by the processor 2 from the design data unit 3 to assess the risk of corrosion is described herewith with reference to a standard Computer Aided Design (CAD) software package, as such Pro/Engineer. It will be appreciated, however, that other design data units and associated packages may be used. In this example, the present invention is implemented as a “plug-in” to the standard design package.

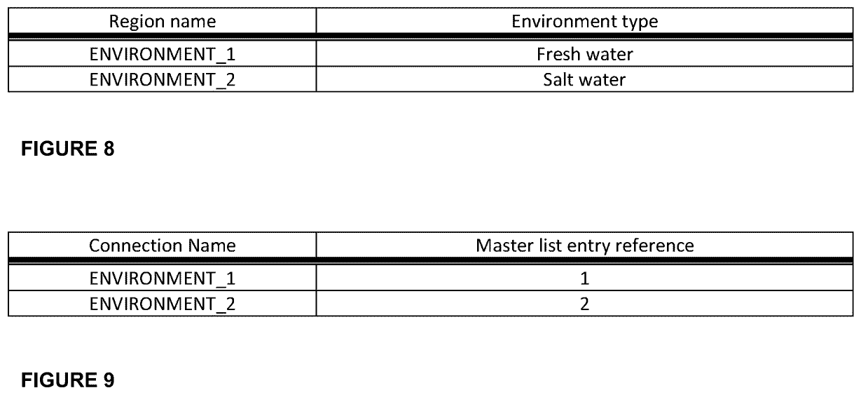

A “master list” of environment regions on a designed mechanical assembly is usually stored in the form of parameters for the designed mechanical assembly. An exemplary design for a mechanical assembly is represented as a model tree in FIG. 7. The parameters may be stored, for example, as name-type pairs where the name identifies a region on the model and the type defines what the environment is made of, out of a predefined selection of possible types. An exemplary master list of environment regions is shown in the table of FIG. 8.

Contacts between parts and environments (also referred to as environment connections) are defined for each part.

FIG. 9 shows an example environment connection list for a part that is in contact with both environments in the master list shown in FIG. 8. In this example, both types of parameters have names beginning with ‘ENVIRONMENT_’ in order to be detected by the model analysis, although it will be appreciated that this is not essential.

The system traverses the design data using appropriate functions (known as “visit functions”, e.g. “ProSolidFeatVisit”, “ProParameterVisit”) to gather a description of all part instances in the model tree, and the materials, environments and environment connections associated with the model. The system then tests all pairs of part instances (using, for example, data identifying part references and assembly tree locations) to see if they are in contact, for example by checking binary interference output parameters.

Environments are assigned IDs when they are detected by the plug-in and these IDs are the references used in connections. Part instance IDs are also used but these are directly constructed from Pro/ENGINEER's feature ID system.

The system may produce an output file, such as an XML output file of information for the analysis in an external software system. The output file includes information on how parts and environment regions are connected and what they are made of (i.e. the material attribute for parts and the value attribute for environment regions).

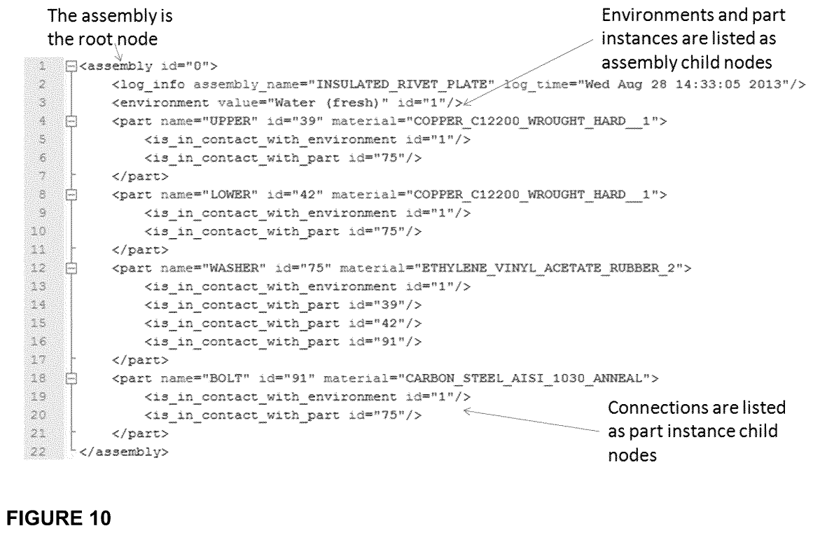

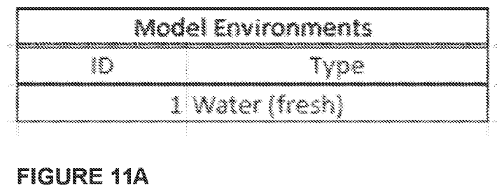

The insulated riveted plates model which was described above with reference to FIG. 3B is used to illustrate the features of the XML output file shown in the example of FIG. 10. It can be seen from this output file that the assembly is the root node, environments and part instances being listed as assembly child nodes. The connections between the part instances and environments are listed as part instance child nodes.

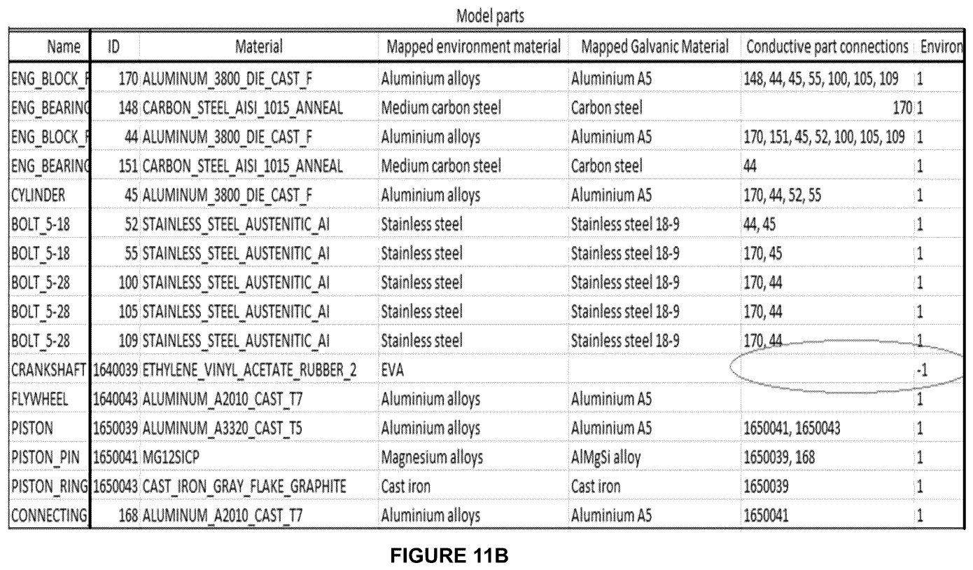

The next step is the analysis of the extracted design data, obtained directly from a software plugin or from the XML output file (as described above), in order to identify corrosion risks. First, the material names in the output file are mapped via static lookup to reference materials in lookup tables (which are part of the obtained corrosion information). The imported design data is stored in a environment table and an part table in the processor as shown schematically in FIGS. 11A and 11B, respectively.

Once the import of design data is complete, the system checks whether each part is conducting via another static lookup for the, already mapped, reference material associated with it. If it is non-conductive, the part cannot form a galvanic cell, therefore its part connections are irrelevant and are cleared from the part table entry. Its environment connections are also unable to take part in galvanic cells, but they can be associated with general corrosion risks, therefore they are not removed from the part table in the same way. Instead, the environment connections are marked to be excluded from galvanic cell calculations, for example by their ID references becoming negative (using the sign as a convenient flag). This negation may also be used for non-conductive environments; alternatively, all environments may be defined as conductive for a worst-case analysis.

Referring to the example shown in FIG. 11B, the oval highlights that a crankshaft part has no conductive connections because it is (arbitrarily and for demonstration purposes only) made of insulating rubber, and equally no parts are electrically connected to it. Additionally, its environment, despite being the same as that of every other part, is marked as negative to indicate that the connection between the crankshaft and the fresh water environment in a galvanic cell should not be included in the connectivity analysis.

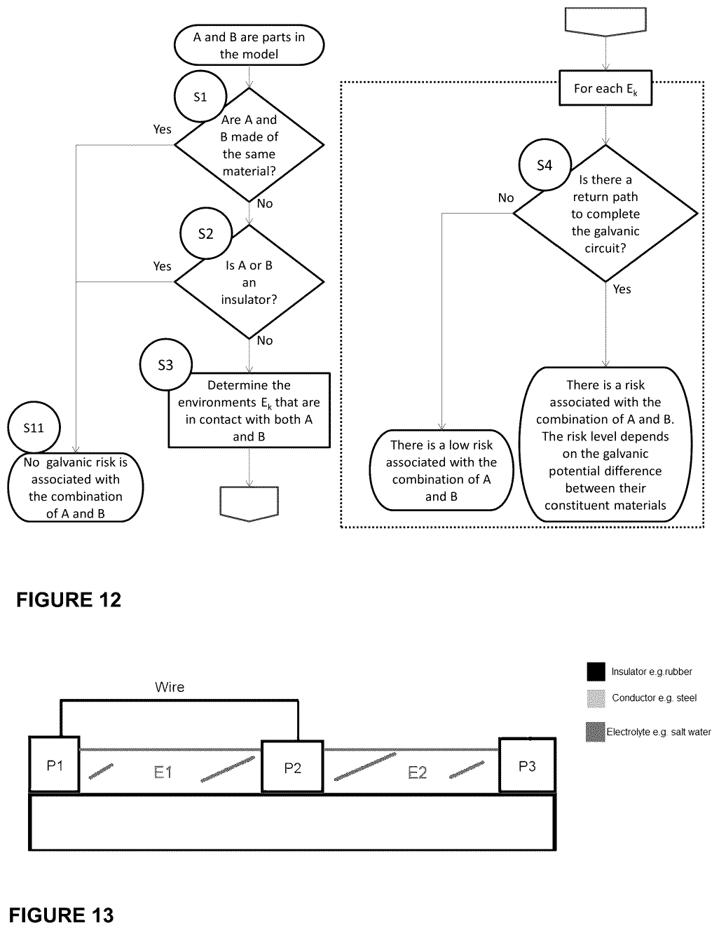

FIG. 12 schematically represents a method in accordance with the present invention. At step S0, all parts in the model are obtained from the design data unit 3, as described above, and then grouped into pairs. For each pair (A, B) in the model, their constituent materials (also stored in the design data unit 3 and obtained as described above) are compared at step S1. The conductivity of each material in the pair (A, B) is analyzed (at step S2), and if either part A or B is non-conductive, than the pair of parts is discarded (at step S11). The “binary conductivity” of individual materials is determined based on conductivity categories assigned, and this information may be obtained from an appropriate reference database stored in the corrosion data unit 4. A binary conductivity is established when both constituent materials in the pair are conductive. Materials rated as poor or good conductors are conductive, while semiconductors and insulators are considered to be non-conductive.

Step S3 determines the environments Ek that are in contact with both parts A and B. If one environment Ek is connected to both parts A and B, a galvanic risk is detected. At step S4, it is determined whether there is a “return path” for A, B, Ek to form a complete galvanic circuit. This requires that A and B are electrically connected by a path that does not include Ek.

There are many material properties that are relevant to corrosion. The corrosion information used by the system (obtained from the corrosion data unit 4) as relevant to the obtained design data (obtained from the design data unit 3) includes conductivity, environmental durability and galvanic potential.

The adjacency of parts is also relevant for corrosion behaviour. If an electrical current can pass between two parts either directly or indirectly, a galvanic corrosion cell can be established. This means that more complex galvanic circuits through parts need to be detected. Advantageously, the system detects electrical connections where a conductive part is in contact with a conductive environment, and these electrical connections are factored into indirect connection calculations.

Once the conductivity of each part and environment is established, a basic adjacency matrix, A, is generated from the remaining direct electrical connections. The indirect electrical connections are extrapolated for each environment as described below.

The adjacency matrix A represents direct contact between parts and environments. For a model with n parts and m environments, A is an (n+m) by (n+m) symmetric matrix.
Aᵢⱼ=1 if three conditions are met:
   At least one of i or j is a part as opposed to an environment
   i and j are both conductive
   i and j are m direct geometric contact

$${A}_{ij} = 0 otherwise$$

Matrix A is then used for stage S4 of the galvanic risk analysis. However, to analyze return paths through common environment Ek (established in S3) are excluded. Matrices AE are produced as follows:

$${A}_{ij}^{{E}_{k}} = {A}_{ij} if i \neq {E}_{k} and j \neq {E}_{k}$$

$${A}_{ij}^{{E}_{k}} = 0 otherwise$$

This direct contact information is extrapolated to both direct and indirect contact as follows:

$${T}^{{E}_{k}} = {\sum }_{r = 1}^{n + m - 1} {( {A}^{{E}_{k}} )}^{r}$$

$${T}_{ij}^{{E}_{k}} = 1 if a path exists between i and j that does not pass through {E}_{k}$$

$${T}_{ij}^{{E}_{k}} = 0 otherwise$$

In order to obtain this binary result, Boolean algebra is used in this example, with addition replaced with Boolean OR, and multiplication replaced with Boolean AND. The matrix TEk is used in Step S4 to analyze galvanic risks.

An example risk analysis is given herewith with reference to a model represented schematically in FIG. 13.

$$A = \begin{matrix}P 1 \\ P 2 \\ P 3 \\ E 1 \\ E 2\end{matrix} \begin{matrix}\begin{matrix}P 1 & P 2 & P 3 & E 1 & E 2\end{matrix} \\ ( \begin{matrix}0 & 1 & 0 & 1 & 0 \\ 1 & 0 & 0 & 1 & 1 \\ 0 & 0 & 0 & 0 & 1 \\ 1 & 1 & 0 & 0 & 0 \\ 0 & 1 & 1 & 0 & 0\end{matrix} )\end{matrix}$$

$${T}^{E 1} = \begin{matrix}P 1 \\ P 2 \\ P 3 \\ E 1 \\ E 2\end{matrix} \begin{matrix}\begin{matrix}P 1 & P 2 & P 3 & E 1 & E 2\end{matrix} \\ ( \begin{matrix}1 & 1 & 1 & 0 & 1 \\ 1 & 1 & 1 & 0 & 1 \\ 1 & 1 & 1 & 0 & 1 \\ 0 & 0 & 0 & 0 & 0 \\ 1 & 1 & 1 & 0 & 1\end{matrix} )\end{matrix}$$

$${T}^{E 2} = \begin{matrix}P 1 \\ P 2 \\ P 3 \\ E 1 \\ E 2\end{matrix} \begin{matrix}\begin{matrix}P 1 & P 2 & P 3 & E 1 & E 2\end{matrix} \\ ( \begin{matrix}1 & 1 & 0 & 1 & 0 \\ 1 & 1 & 0 & 1 & 0 \\ 0 & 0 & 0 & 0 & 0 \\ 1 & 1 & 0 & 1 & 0 \\ 0 & 0 & 0 & 0 & 0\end{matrix} )\end{matrix}$$

It can be seen from the example represented in FIG. 13 that component parts P1 and P2 have a common environment E1 and that, from TE1 there is a conductive path for this risk cell. It can also be seen that parts P2 and P3 have common environment E2, and that, from TE2 there is no conductive path for this risk cell.

In summary, the analysis of the imported XML design data (or in the plugin) may include the following steps:
All pairs of parts with a common environment are detected as potential galvanic corrosion risks, and all parts in environments are detected as general corrosion risks;
Potential galvanic corrosion risks are removed if both parts are the same material or if either part is non-conductive;
Each potential galvanic risk is checked for a return path completing the galvanic circuit, and the outcome of this check is recorded with the risk; and
Risk ratings are calculated for each potential risk.

A report generator may be used to generate a risk assessment report based on the indication provided by the processor. The risk assessment report may include galvanic corrosion risks, general corrosion risks, and risk ratings.

As described above, the analysis required for generating a risk report uses adjacency checks to produce a list of all part-environment adjacent pair general corrosion risks, and all adjacent anode-electrolyte-cathode group galvanic corrosion risks, noting whether a connection exists to complete the circuit for the galvanic risk. Galvanic risks are eliminated from the list if the two parts involved are made of the same material. Each of these parts are assigned a risk level (and possibly combined into a smaller number of separate entries) when the report is generated.

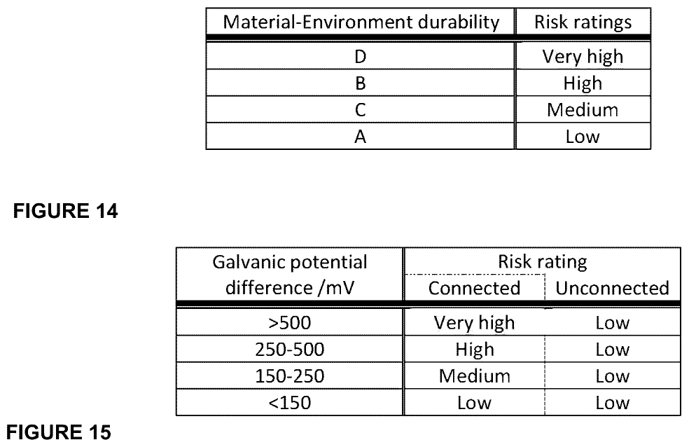

For general corrosion risks, the risk ratings may be based on environment durability data source, ranging from A (Low risk rating) to D (very high risk rating), as represented in the table of FIG. 14. For galvanic corrosion risks, the rating is preferably based both on galvanic potential data and on whether there is a complete electrical circuit for the galvanic cell, as defined above (an example of which is given in FIG. 15).

Corrosion risks may relate to ‘uncompleted cells’, as discussed above with references to FIGS. 3A and 3B. As explained above, corrosion may still be possible in uncompleted cells by diffusion of ions between the parts. For uncompleted cells, the risk is identified by the system, but it may be rated as ‘low’, for example in the risk assessment report in FIG. 15, regardless of the potential difference.

There are several possible enhancements to risk ratings which are envisaged. Additional risk analysis may take into account, for example, detailed information such as surface area ratios and the possibility of diffusion between environments. Conservation of current means that the surface area ratio between anode and cathode contact with the environment can drastically affect corrosion risk. To use this information, there needs to be precise specification of what surfaces of a part are in contact with an environment.

Further, a simple binary test that could be added is whether the environment is likely to be a continuous body through which diffusion can occur between the electrodes of a galvanic cell (i.e. a bulk liquid) or whether it is a gas or condensation. This affects the risk level in the case where there is no return path for the environment and could be represented as medium risk for liquid environments and low risk for gaseous environments

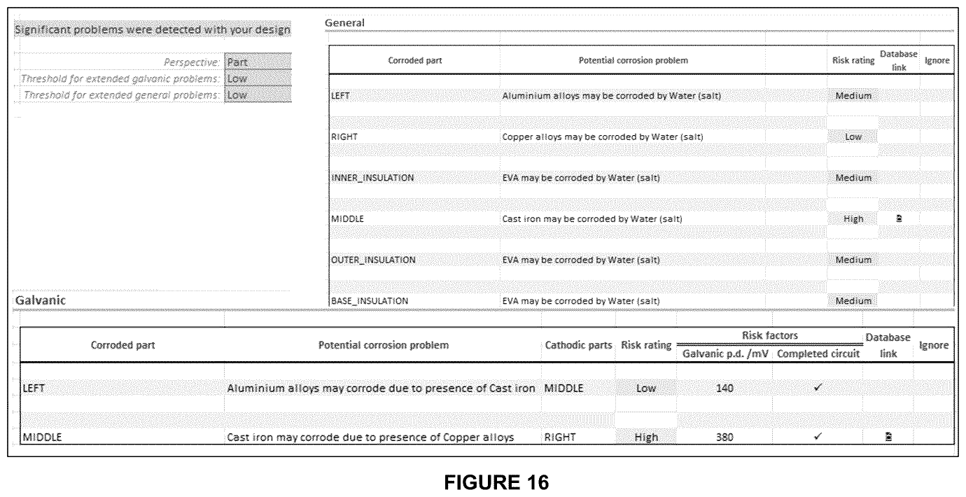

An example of a risk report is shown in FIG. 16. The risk report contains a table for galvanic risks and a table for general risks. Risk levels are calculated for the potential risk list by static lookup of general durability rating or galvanic potential difference.

Information presented in the risk entries includes: the combination of materials and environments involved in the risk; the part that is corroded, the risk rating (with a traffic light-type colour); and a link to the case database if a similar case exists. Additionally, information in the galvanic table includes: parts acting as cathodes for the risk cell; the galvanic potential difference of the cell; and the result of the connectivity calculation for the cell (as ✓=completed cell or x=uncompleted cell).

Risks are combined when they are indistinguishable from the corroded part's perspective (e.g. due to the simplicity of the analysis). If the same part is corroded, the same materials and environment types are involved, and the connectivity is the same, then only one entry is produced regardless of specific environment bodies and cathodic parts. When viewed from the perspective of corroded materials, entries are compressed even further with all corroded parts of the same material having their equivalent entries combined.

The header of the report may indicate the name of the assembly and when the corrosion snapshot of the assembly taken (i.e. when the XML was generated). It may also was t indicate a ‘good’ or ‘bad’ rating of the assembly which is based on whether there are high corrosion risks present. There may be fields with dropdown menus to control the content of the report. These fields would select between part- or material-based layouts, and set the lowest risk level that is displayed for each corrosion type.

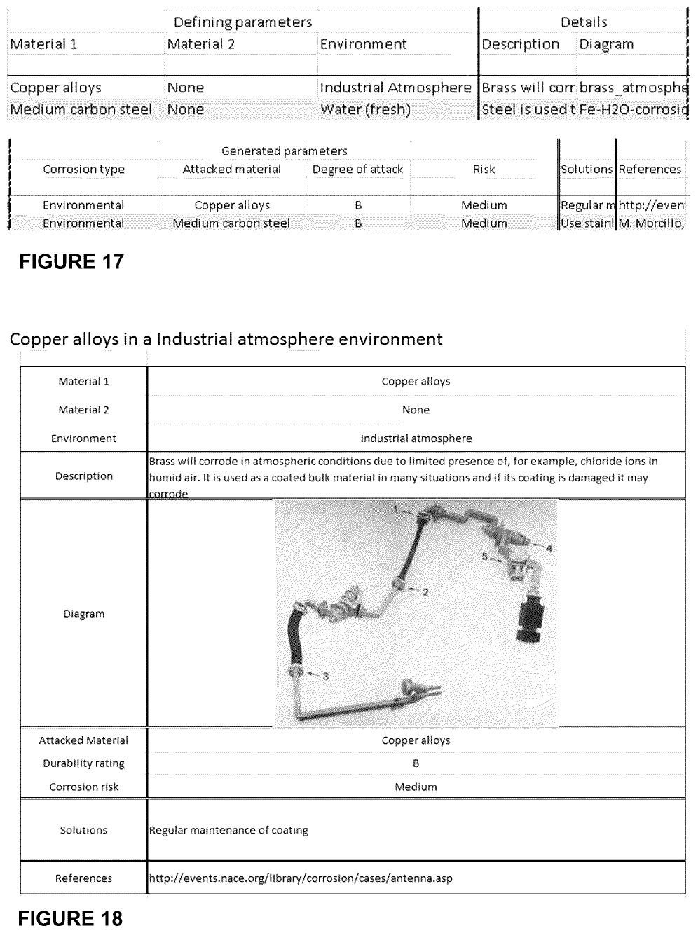

FIG. 17 shows another risk report, in an Excel table which is split in two in order to make it more readable. Cases are indexed by materials and environment. Each case refers to an illustrative example which includes a diagram and a description. The case database stored in the corrosion data unit 4 uses static lookups to fill in durability data and risk ratings. Cases also include corrosion prevention solutions for, and references to, their illustrative example.

The risk report may generate a case datasheet link whenever a report risk matches an entry in the case database stored in the corrosion data unit 4. Matches are detected when the materials and environment are the same for the report risk and the database entry. The intent of the case database is to provide general advice and to be used to store company design policies regarding corrosion, with the company-wide solution to a particular type of corrosion risk (such as iron in contact with copper, solved by application of a coating) automatically linked when a model-specific report detects that risk.

Navigating a datasheet link in the risk report transfers the view to a worksheet filled in with the relevant corrosion case entry, as shown in FIG. 18.

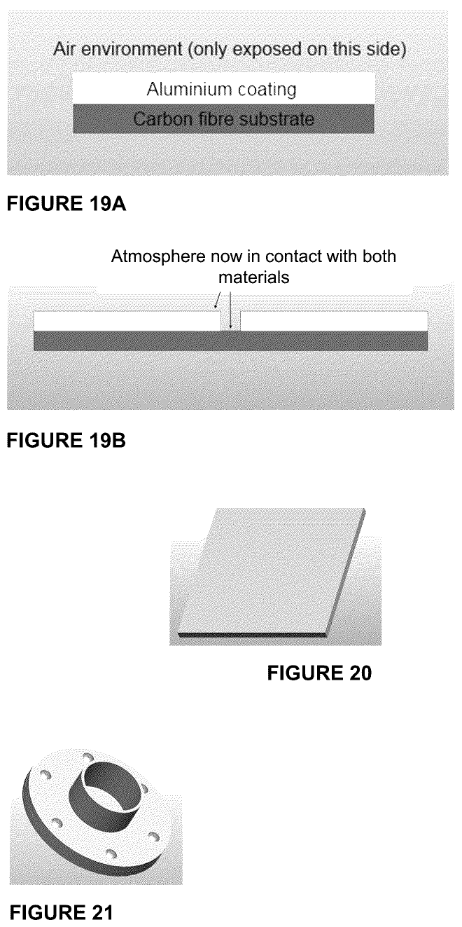

A set of model assemblies has been created that tests a variety of corrosion criteria, and this set was used to validate the implementation of the system described above. These model assemblies include a pair of riveted plates, with and without insulation, as shown in FIGS. 2B and 3B, respectively, which test the analysis of connected parts and conductivity of materials. Further model assemblies include two mated sheets representing a coated surface, with and without a scratch (as shown in FIGS. 19A and 19B, respectively), to test the method's ability to respond to imperfections in a surface.

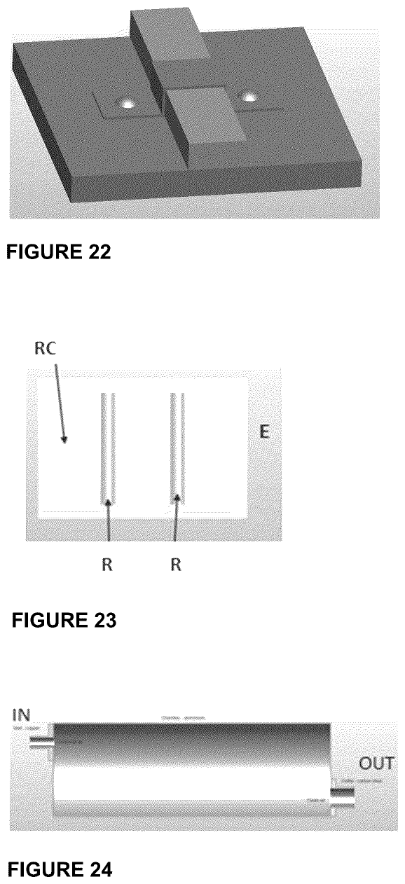

FIG. 20 shows a very basic single object in an environment, useful early on as a basic functionality check. FIG. 21 shows a closed pipe, which could be used to test analysis of flow effects. FIG. 22 shows a saddle joint, which could be used to test geometric analysis such as crevice corrosion. FIG. 23 shows a block of reinforced concrete RC, with embedded reinforcing bars R made from stainless steel, in a salt water environment E. The block of reinforced concrete is a very common corrosion situation because concrete is so widely used. FIG. 24 shows an exhaust system, which has the ability to test gradual environment change. The exhaust system is made of a chamber of aluminum, with an outlet of copper for letting in corrosive air, and an outlet of carbon steel for letting out clean air. A battery with two galvanic cells in series, which tests the analysis of more complex scenarios, was described above with reference to FIG. 6B.

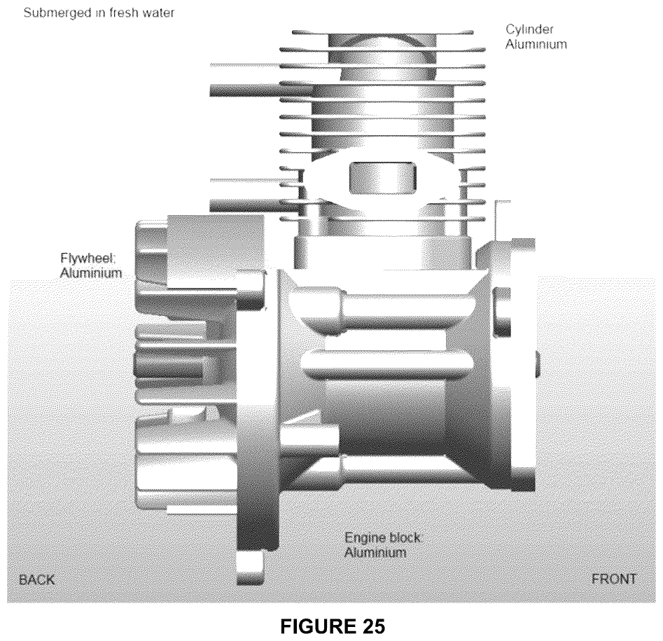

FIG. 25 shows an example of an engine representing a drill model consisting of 16 parts, which tests the analysis of a larger model. The engine is largely made of ferrous materials and aluminum. The engine is submerged in fresh water, but some parts are internal and therefore not in contact with the water. The model is designed in Pro/ENGINEER, and has materials and environments assigned through a software plugin. The plug-in is run and design data is extracted in the form of XML data, which is then used by a “report tool” to generate a risk assessment report based on the comparison with the relevant corrosion data. Alternatively the plugin could generate the risk assessment report itself without need for the external tool and XML file.

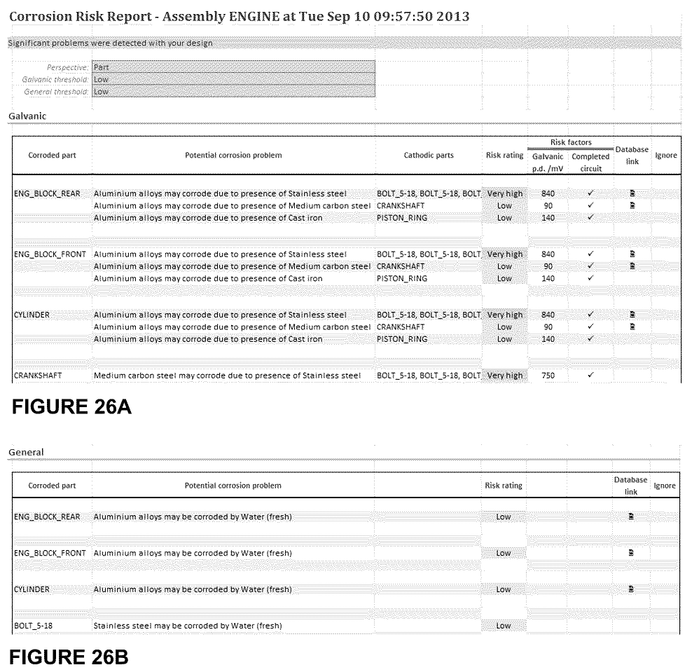

One might expect that making the engine's bolts from stainless steel would reduce total corrosion risk since stainless steel is a noble metal. However, the system correctly identifies in the report that this is not the case. An excerpt from the galvanic table in the report for this drill model is shown in FIG. 26A. Although the bolts themselves are not corroded, they act as cathodes for high risk galvanic cells corroding the largest parts of the assembly—the engine block and cylinder—and lead to corrosion risks with both aluminum and medium carbon steel.

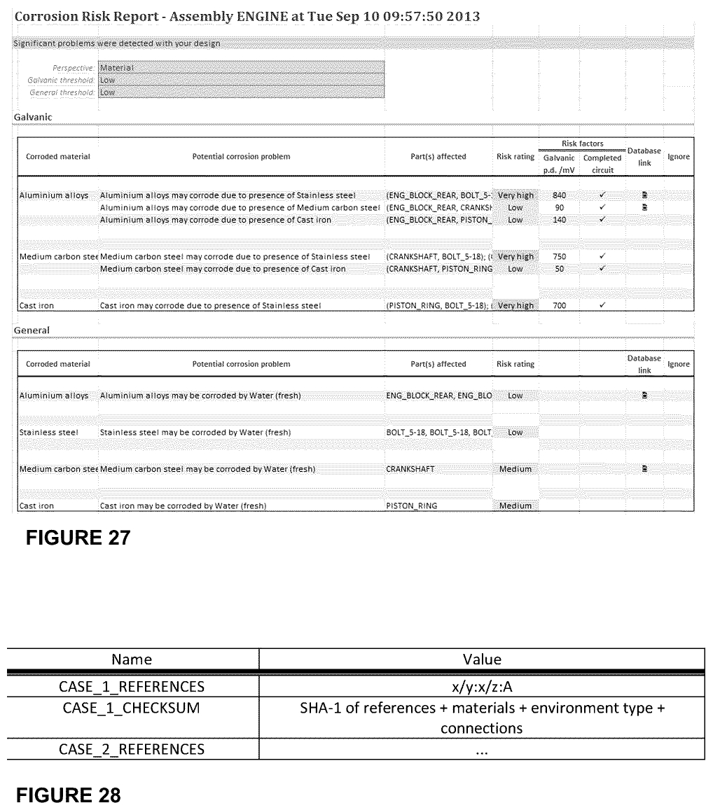

The general corrosion table from the report, as illustrated in FIG. 26B, shows that direct corrosion of the parts by the environments is less of a concern. This example also shows the merit of sorting material-based report where the risk due to the bolts is more evident, as illustrated in FIG. 27. The list of risks in this example is very short in terms of materials because there are so few different materials in the model. As a result, high proportion of entries—all of the high risk entries in fact—are contributed to by stainless steel in the bolts.

The report may be generated in the form of a “dashboard” (not shown) in the interface 2. A summary dashboard report may also be implemented to provide risk counts from the analysis, and compare these to a baseline. Such a “dashboard report” may act as a filter control for viewing specific detected risks.

An assembly-specific corrosion risk dismissal functionality is envisaged. The reasoning behind this functionality is that it is very possible that the corrosion analysis to not have enough information to dismiss some cases where there is a mitigating factor that lowers risk. In such cases, with this functionality, the user may, either by picking up on information that the tool is not aware of, or by already being aware of a solution to a particular risk, decide that they don't want that risk cluttering the report. In that situation, it would be useful to add it to a list of risks for the report to ignore, which would be associated with the particular assembly.

FIG. 7 discussed above schematically shows a model tree. The ignored risks may be stored either for the assembly or for the corroded assembly component. They may be stored, for example, as a set of tree references to the model parts and environments involved in the case, with a checksum that uses the data previously found at those tree references in order to establish whether the case is still relevant.

Referring to FIG. 28, x, y and z are feature references defined by the CAD software and A is an assigned reference which may be used to store a case reference. The checksum would have to factor in the references, the materials of the parts, the type of the environment and the connections associated with the parts in order to incorporate all the information that might change and make the case irrelevant. Without this, the system could ignore a risk that is different from the risk originally stored. These risks would have to be attached to a “Bill of Materials” (BOM) in order to be incorporated into the report.

It will be appreciated that the user interface 2 has functionality to enable a user of the system to interact in an appropriate manner with the design and corrosion data used in the analysis. Such functionality may include, for example, selecting or highlighting by the user of one or more component parts in contact with a given environment. The selected parts could be deleted, renamed, or linked to datasheets storing data associated with the selected parts. Alternatively or additionally, a component part may be added by the user. A default name or type of the part may be used and the system may automatically set environments, or connections between parts and environments.

For example, functionality may be implemented to manually assign connections between parts and environments, as well as customization. For complex mechanical assemblies, automatic environment setup is preferred. This setup may be done, for example, by a “flood fill” analysis algorithm, which requires geometric knowledge of the empty space regions in the model and what parts are in contact with these regions.

An example of a method for analyzing this in the Pro/ENGINEER package includes the following steps:
Establish a bounding box for the model;
Use ray tracing starting from points on a grid on one the box faces. This will provide ranges at which the rays intersect with faces, and the details (including owner parts) of the faces; and
Convert the results from the 2D grid ray tracing to a 3D grid for use with a flood-fill algorithm, using the surface ownership data to record what parts are where in the grid.

The flood fill algorithm can run in a package-independent context, for other CAD packages where a 3D grid can be established. There are several different coordinate systems used in both the inputs and outputs of such algorithms.

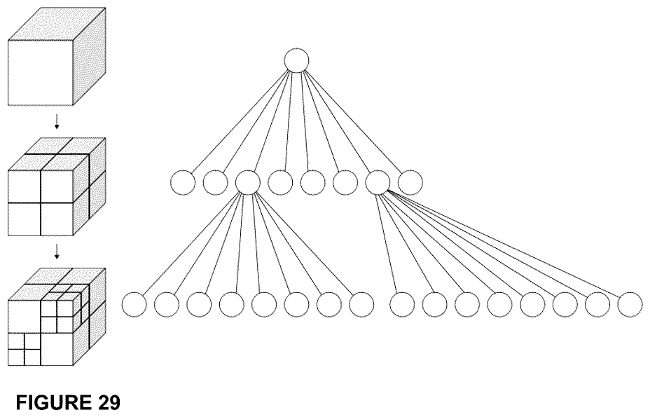

To implement the flood-fill algorithm, octrees known in the art are an efficient strategy for filling in the grid. These involve starting with a low resolution grid and only subdividing it where more detail is needed (i.e. where a cell overlaps several regions Examples of octree diagrams are shown in FIG. 29.

It will also be appreciated that the specific feature of the system or method steps may be altered without departing from the present examples. In particular, the specifics of the user interface or corrosion report may change according to design requirements and any particular design packages used.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination.

1-34. (canceled)

35. A system for identifying a corrosion risk of a mechanical assembly, the system comprising one or more processors configured to:
(a) receive a set of design data that represents the mechanical assembly, wherein the set of design data comprises data for a plurality of parts of the mechanical assembly, at least one material associated with each of the plurality of parts, and at least one environment associated with each of the plurality of parts;
(b) receive a set of corrosion data that is associated with the set of design data;
(c) determine a corrosion risk associated with the mechanical assembly based on the set of design data and the set of corrosion data, wherein the corrosion risk comprises a general corrosion risk and a galvanic corrosion risk; and
(d) provide a description of the corrosion risk;
wherein the one or more processors are configured to, when determining the corrosion risk:
(i) determine the general corrosion risk for each of the plurality of parts based on the at least one material and the at least one environment associated with that part;
(ii) determine a plurality of part pairs based on the set of design data, where each of the plurality of part pairs comprises a first part and a second part that are joined by a conductive connection;
(iv) for each part pair of the plurality of part pairs:
(A) determine if there is a complete galvanic circuit for the first part and the second part; and
(B) determine the galvanic corrosion risk based on a galvanic potential difference between the at least one material of the first part and the second part, and whether the complete galvanic circuit exists.

36. The system of claim 35, wherein the one or more processors are further configured to, when determining if the complete galvanic circuit exists for the first part and the second part:
(i) determine, based on the plurality of part pairs, whether a direct return path exists between the first part and the second part, wherein the direct return path comprises a single conductive connection between the first part and the second part;
(ii) determine, based on the plurality of part pairs, whether an indirect return path exists between the first part and the second part, wherein the indirect return path comprises two or more sequential conductive connections between the first part and the second part.

37. The system of claim 36, wherein the single conductive connection and the two or more sequential conductive connections comprise a part of the plurality of parts other than the first part and the second part, an environment other than a common environment shared by the first part and the second part, or both.

38. The system of claim 35, wherein the one or more processors are further configured to, prior to determining the corrosion risk, discard from the plurality of part pairs each part pair where:
(i) the first part and the second part share a common set of associated materials;
(ii) the first part or the second part is non-conductive; or
(iii) the first part and the second part do not share a common environment.

39. The system of claim 35, wherein the one or more processors are further configured to, after receiving the set of design data as a structured output file:
(i) identify a plurality of materials referenced in the structured output file, and map each of the plurality of materials to a reference material in the set of corrosion data;
(ii) identify the plurality of parts referenced in the structured output file, and store the plurality of parts in a part table; and
(iii) use the environment table and the part table as the set of design data.

40. The system of claim 39, wherein the part table comprises, for each of the plurality of parts, a part identifier, one or more materials of the plurality of materials, one or more mapped reference materials, one or more conductive connections, and one or more environments of the plurality of environments.

41. The system of claim 40, wherein the one or more processors are further configured to, prior to determining the corrosion risk, for any part that is non-conductive based on the one or more mapped reference materials:
(i) discard, from the part table, the one or more conductive connections for that part;
(ii) mark, in the part table, the one or more environments for that part so that they are excluded when determining the galvanic corrosion risk, but still used when determining the general corrosion risk.

42. The system of claim 41, wherein the one or more environments are stored in the part table as numerical environment identifiers, and wherein the one or more environments for that part are marked for exclusion when determining galvanic corrosion risk by modifying the numerical environment identifiers to a negative value.

43. The system of claim 35, wherein the one or more processors are further configured to, when providing the description of the corrosion risk, cause a corrosion risk report to be displayed on a display.

44. The system of claim 43, wherein the corrosion risk report comprises:
(i) a description of the general corrosion risk that includes a first set of corroded parts, a summary of the potential corrosion problem for each of the first set of corroded parts, and a risk rating for each of the first set of corroded parts; and
(ii) a description of the galvanic corrosion risk that includes a second set of corroded parts, a summary of the potential corrosion problem for each of the second set of corroded parts, and a risk rating for each of the second set of corroded parts.

45. The system of claim 43, further comprising a case database configured to store a plurality of cases, wherein each case of the plurality of cases comprises one or more case materials, one or more case environments, a case diagram, and a case description, wherein the corrosion risk report comprises:
(i) the description of the corrosion risk; and
(ii) a case link interface element that is configured to be selected to cause the corrosion risk report to display a matching case from the case database.

46. The system of claim 43, wherein the corrosion risk report comprises, for each corroded part of a set of corroded parts, a first description of the galvanic corrosion risk that is based on that corroded part being associated with a complete galvanic circuit, and a second description of the galvanic corrosion risk that is based on that corroded part being associated with an incomplete galvanic circuit.

47. A method for identifying a corrosion risk of a mechanical assembly comprising, by one or more processors:
(a) receiving a set of design data that represents the mechanical assembly, wherein the set of design data comprises data for a plurality of parts of the mechanical assembly, at least one material associated with each of the plurality of parts, and at least one environment associated with each of the plurality of parts;
(b) receiving a set of corrosion data that is associated with the set of design data;
(c) determining a corrosion risk associated with the mechanical assembly based on the set of design data and the set of corrosion data, wherein the corrosion risk comprises a general corrosion risk and a galvanic corrosion risk; and
(d) providing a description of the corrosion risk;
the method further comprising, when determining the corrosion risk:
(i) determining the general corrosion risk for each of the plurality of parts based on the at least one material and the at least one environment associated with that part;
(ii) determining a plurality of part pairs based on the set of design data, where each of the plurality of part pairs comprises a first part and a second part that are joined by a conductive connection;
(iv) for each part pair of the plurality of part pairs:
(A) determining if there is a complete galvanic circuit for the first part and the second part; and
(B) determining the galvanic corrosion risk based on a galvanic potential difference between the at least one material of the first part and the second part, and whether the complete galvanic circuit exists.

48. The method of claim 47, further comprising, when determining if the complete galvanic circuit exists for the first part and the second part:
(i) determining, based on the plurality of part pairs, whether a direct return path exists between the first part and the second part, wherein the direct return path comprises a single conductive connection between the first part and the second part;
(ii) determining, based on the plurality of part pairs, whether an indirect return path exists between the first part and the second part, wherein the indirect return path comprises two or more sequential conductive connections between the first part and the second part.

49. The method of claim 47, further comprising, prior to determining the corrosion risk, discarding from the plurality of part pairs each part pair that is not a galvanic risk based on the associated at least one material and at least one environment.

50. The method of claim 47, further comprising, when providing the description of the corrosion risk, causing a corrosion risk report to be displayed on a display.

51. The method of claim 50, wherein the corrosion risk report comprises descriptions, based on the general corrosion risk and galvanic corrosion risk, that include for each of a set of corroded parts a summary of the potential corrosion problem and a risk rating.

52. The method of claim 50, wherein the corrosion risk report comprises:
(i) the description of the corrosion risk; and
(ii) a case link interface element that is configured to be selected to cause the corrosion risk report to display a matching case from a case database;
wherein the case database is configured to store a plurality of cases, and wherein each case of the plurality of cases comprises one or more case materials, one or more case environments, a case diagram, and a case description.

53. The method of claim 50, wherein the corrosion risk report comprises, for each corroded part of a set of corroded parts, a first description of the galvanic corrosion risk that is based on that corroded part being associated with a complete galvanic circuit, and a second description of the galvanic corrosion risk that is based on that corroded part being associated with an incomplete galvanic circuit.

54. A method for identifying a corrosion risk of a mechanical assembly comprising:
(a) providing a set of design data that represents the mechanical assembly to a corrosion risk assessment computer, wherein the set of design data comprises data for a plurality of parts of the mechanical assembly, at least one material associated with each of the plurality of parts, and at least one environment associated with each of the plurality of parts;
(b) receiving a corrosion risk dataset from the corrosion risk assessment computer, and displaying a corrosion risk report on a display based on the corrosion risk dataset;
wherein the corrosion risk dataset comprises:
(i) a general corrosion risk for each of the plurality of parts that is determined based on the at least one material and the at least one environment associated with that part; and
(ii) a galvanic corrosion risk for each of the plurality of parts that is determined based on:
(A) a grouping of the plurality of parts into a plurality of part pairs based on the set of design data, wherein each of the plurality of part pairs comprises a first part and a second part that are joined by a conductive connection; and
(B) for each part pair of the plurality of part pairs:
(I) a determination of whether there is a complete galvanic circuit for the first part and the second part; and
(II) a determination of the galvanic corrosion risk based on a galvanic potential difference between the at least one material of the first part and the second part, and whether the complete galvanic circuit exists.
